(19) United States
(12) Patent Application Publication
(10) Pub. No.: US 2026/0089810 A1
(43) Pub. Date: Mar. 26, 2026

(54) INDUCTION HOB DEVICE

(71) Applicant: BSH Hausgeräte GmbH, Munich (DE)

(72) Inventors: Diego Puyal Puente, Zaragoza (ES); Arturo Acevedo Simon, Zaragoza (ES); Nicolas Blasco Rueda, Zaragoza (ES); Jorge Español Leza, Zaragoza (ES); Alvaro Hernando Carnicer, Zaragoza (ES)

(21) Appl. No.: 19/109,622

(22) PCT Filed: Sep. 8, 2023
(86) PCT No.: PCT/EP2023/074701

§ 371 Date: Mar. 7, 2025

(30) Foreign Application Priority Data
Sep. 16, 2022 (EP) 22382855.9

(51) Int. Cl. H05B 6/12; H02M 1/00; H02M 7/04; H05B 6/04

(52) U.S. Cl. CPC H05B 6/1209; H02M 1/0058; H02M 7/04; H05B 6/04

(57) ABSTRACT

An induction hob apparatus includes a network connection connected to a current supply network, a rectifier, and a bus capacitor connected to the network connection via the rectifier via a first charging path for charging during a positive network voltage partial cycle and via a second charging path for charging during a negative network voltage partial cycle. A discharging unit includes at least two switch units, each including a switch element for periodic discharging of the bus capacitor via the current supply network. One switch unit is embodied as a high-side switch unit with a high-side switch element and another switch unit is embodied switch units as a low-side switch unit with a low-side switch element. The switch elements of the at least two switch units are provided to enable, in a closed state, a discharging path from the bus capacitor back to the network connection.

The invention relates to an induction hob apparatus as claimed in the preamble of claim 1, to an induction hob as claimed in claim 15 and to a method for operation of the induction hob apparatus as claimed in claim 16.

Induction hob apparatuses with at least one bus capacitor are already known from the prior art, upstream from which a rectifier can be connected for example. For a few applications, for example for detecting cookware on the basis of rectifier power measurements at high sample rates, it can be expedient for the bus capacitor to be discharged at least partly or completely from time to time, in order to prevent interference noises for example. Previously known methods for discharging of bus capacitors, for example via high-resistance resistors, are associated in such cases with high electrical losses, so that an efficiency of previously known induction hob apparatuses with respect to a discharging of bus capacitors is disadvantageously very low.

The object of the invention lies in particular in, but is not limited to, providing a generic apparatus with improved properties with respect to efficiency. The object is achieved in accordance with the invention by the features of claims 1, 15 and 16, while advantageous embodiments and developments of the invention can be taken from the subclaims.

The invention is based on an induction hob apparatus with at least one bus capacitor, with at least one rectifier and with a network connection for connection to a current supply network, wherein the bus capacitor is connected to the network connection via the rectifier via at least one first charging path for charging during a positive network voltage partial cycle and via at least one second charging path for charging during a negative network voltage partial cycle.

It is proposed that the induction hob apparatus has a discharging unit, which comprises at least two switch units with at least one switch element in each case for a periodic discharge of the bus capacitor via the current supply network, wherein one of the switch units is designed as a high-side switch unit with a high-side switch element and one of the switch units as a low-side switch unit with a low-side switch element and the switch elements are provided such that, in a closed state, they enable a discharging path from the bus capacitor back to the network connection.

Such a design advantageously enables an induction hob apparatus with improved properties with respect to efficiency to be provided. In particular a periodic at least partial discharge of the bus capacitor can be made possible with negligible losses. By comparison with known dissipative methods for discharging bus capacitors, for example via a high-resistance resistor, advantageously up to 10 W per phase can be saved when the discharging unit comprises at least two switch elements for discharging the bus capacitor periodically via the current supply network that, in a closed discharge state, enable a discharging path from the bus capacitor back to the network connection. An especially efficient cookware vessel detection on the basis of rectifier power measurements can further advantageously be made possible at high sampling rates by the induction hob apparatus.

An “induction hob apparatus” is to be understood as at least one part of, in particular a submodule of, an induction hob, wherein in particular accessory units for the hob can additionally be included, such as for example a sensor unit for external measurement of a temperature of cookware and/or of a pot. In particular the induction hob apparatus can also comprise the entire induction hob.

An induction hob having the induction hob apparatus comprises at least one inductor that, in at least one operating state, provides energy in the form of an electromagnetic alternating field to at least one object, in particular to an item of cookware, and a rectifier unit with at least two rectifier switch elements for supply of energy to the inductor. The rectifier switch elements of the rectifier unit can be embodied in this case as semiconductor switch elements, in particular as transistors, for example via Metal-Oxide Semiconductor Field Effect Transistors (MOSFET) or Organic Field Effect Transistors (OFET), advantageously as bipolar transistors preferably with Isolated-Gate Electrode (IGBT). The at least one bus capacitor of the induction hob apparatus, in an installed state of the induction hob having the induction hob apparatus, is preferably arranged electrically in parallel with the at least two rectifier switch elements of the rectifier.

The network connection of the induction hob apparatus is preferably provided for connection to a multi-phase current supply network. In one operating state the induction hob apparatus is connected via the network connection to the current supply network and is supplied with an AC network voltage. The AC network voltage switches over its electrical polarity periodically within a network voltage cycle of which the period duration corresponds to the duration of the period of the reciprocal of the network frequency, wherein the period duration, for a network frequency of for example 50 Hz, which is typical for European current supply networks, lasts 20 ms. During the positive partial network voltage cycle, which corresponds to half a period duration of the AC network voltage, the AC network voltage has a positive electrical polarity and during the negative partial network voltage cycle, which corresponds to half a period duration of the AC network voltage, it has a negative electrical polarity.

The rectifier is connected to the network connection and is provided to rectify the AC network voltage present at the network connection in the operating state, preferably into a pulsing DC voltage. The rectifier is preferably embodied as a single-phase full-wave rectifier. As an alternative however use of a multi-phase full-wave rectifier, in particular of a three-phase rectifier, is conceivable, without departing from the scope of the invention described above and below. The rectifier preferably comprises at least four rectifier elements, in particular diodes and/or thyristors and/or transistors and/or the like, which, in at least one switching state, make a flow of current possible in a forward direction and, in at least one further switching state, block a flow of current in a blocking direction. Preferably at least two of the rectifier elements are assigned to the first charging path and are provided to connect the bus capacitor to the network connection during the positive network voltage partial cycle. Preferably at least two of the rectifier elements are assigned to the second charging path and are provided to connect the bus capacitor to the network connection during the negative network voltage partial cycle.

The discharging unit is provided for an at least partial or complete discharging of the bus capacitor within at least one network voltage partial cycle and to this end has the at least two switch elements that, in their closed state, enable the discharging path. The discharging unit can be provided for an at least partial or complete discharging of the bus capacitor within the positive network voltage partial cycle, wherein to this end one of the switch elements is arranged in each case electrically in parallel with one of the rectifier elements of the rectifier unit in each case, which are assigned to the positive charging path and the switch elements are provided to bridge these rectifier elements in their closed state for the partial or complete discharging of the bus capacitor. The discharging unit, as an alternative or in addition, for partial or complete discharging of the bus capacitor, can be arranged within the negative network voltage partial cycle, wherein to this end one of the switch elements is arranged in each case electrically in parallel with one of the rectifier elements of the rectifier unit, which are assigned to the positive charging path and the switch elements are provided to bridge these rectifier elements in their closed state for the partial or complete discharging of the bus capacitor. It is also conceivable for the discharging unit for at least partial or complete discharging of the bus capacitor to be provided via a first discharging path within the positive network voltage partial cycle and to be provided via a second discharging path within the negative network voltage partial cycle and, to this end, to have at least four switch elements, wherein two of the switch elements in each case are embodied as high-side switch elements and two of the switch elements as low-side switch elements in each case, and wherein one of the switch elements in each case is arranged electrically in parallel with one of the rectifier elements of the rectifier unit in each case.

A “high-side switch unit” or a “high-side-switch element” is to be understood in this context as a switch unit or a switch element that, in an installed state of the induction hob apparatus, is arranged between a positive conductor, in particular a current-carrying conductor, of the network connection and an electrical load, in particular the bus capacitor. A “high-side switch unit” or a “low-side switch element” is to be understood in this context as a switch unit or a switch element that, in the installed state of the in the induction hob apparatus, is arranged between a negative conductor, in particular a neutral conductor and/or neutral, of the network connection and the electrical load, in particular the bus capacitor.

A “switch unit” is to be understood as a unit that has at least one activatable switch element. The claimed discharging unit has a first switch unit, which is embodied as the high-side switch unit, and which has a first switch element that is embodied as the high-side switch element. The claimed discharging unit further has a second switch unit, which is embodied as the low-side switch unit, and which has a second switch element that is embodied as the low-side switch element.

The switch units and/or the switch elements of the discharging unit can be embodied as unidirectional switch units and/or switch elements, meaning that, in the closed state, they make possible a flow of current in a first direction and block it in a second direction opposite to the first direction. It is also conceivable for the switch units and/or switch elements to be embodied as bidirectional switch units and/or switch elements, meaning that, in the closed state, they make a flow of current possible both in the first direction and also in a second direction opposite to the first direction. The discharging unit can be embodied at least in part in one piece with the rectifier. The fact that the two units are embodied “at least in part in one piece” is to be understood as the units having at least one, in particular at least two, advantageously at least three, common elements that are a component, in particular a functionally important component, of both units. For example, it is conceivable for at least one rectifier switch element of the rectifier to also function at the same time as a switch element of the discharging unit.

In the present document ordinal numbers, such as for example “first” and “second”, which are placed before certain terms, merely serve to distinguish between objects and/or as an assignment between objects and do not imply any overall number and/or order of the objects. In particular a “second object” does not necessarily imply that a “first object” is present.

“Provided” is to be specifically understood as programmed, designed and/or equipped. The fact that an object is provided for a specific function is to be understood as the object fulfilling and/or carrying out the specific function in at least one application state and/or operating state.

In an advantageous embodiment of the invention, it is proposed that the switch units are each embodied as a voltage-bidirectional two-quadrant switch. A voltage-bidirectional two-quadrant switch having a switch element conducts current in particular only in one direction, in particular in a closed, conducting state of the switch element, and in particular blocks voltage at least in an opened, non-conducting state of the switch element in both directions.

Through this an advantageous protection of the switch elements can be achieved, in particular when these are each embodied as a MOSFET. In particular it can be avoided that a current, instead of flowing through a component, in particular a diode, of the rectifier, flows through an area connected in parallel with the component, in particular through an intrinsic diode, of the switch element, in particular the MOSFET. In the case of two diodes connected in parallel with each other a large part of the current namely flows in particular through that diode with the lower voltage drop, wherein through a heating-up of the diode associated with a flow of current, in particular the voltage drop falls further, so that the effect amplifies itself. Through this the case can occur in particular in which an initially desired current distribution, through the heating-up of the two diodes connected in parallel, changes as the heating-up increases into an undesired current distribution, which can be associated with damage to components, in particular to the MOSFET. The embodiment as a voltage-bidirectional two-quadrant switch enables it to be ensured that, at least in an opened state of the switch element, a voltage drop across components, in particular diodes, of the rectifier is lower than across the switch unit. In particular the use of dissipative elements, in particular ohmic resistors, can also be dispensed with, whereby installation space can be reduced and/or energy efficiency increased, in particular despite the additional voltage drop occurring at the PN gate of the protective diode, which however is in particular substantially independent of current intensity. No disadvantageous influencing of the bus voltage that can be achieved is thus also to be expected after discharging. Moreover, requirements on components, in particular on the switch element, can be reduced. This in particular enables a switch element, preferably a MOSFET, with a relatively low current capacity to be used, whereby the need for installation space and/or costs can be reduced. A reliable complete discharging of the bus capacitor can further be ensured, since a flow of current is not further inhibited by an additional ohmic resistor. An “intrinsic diode” of the switch element is in particular to be understood as an area of the switch element that acts like a diode, in particular like a PN gate.

Advantageously both switch units each have a protective diode connected in series with the respective switch element, whereby a particularly advantageous and simple implementation of a voltage-bidirectional two-quadrant switch can be achieved. In particular it can be ensured that each component only carries out the task assigned to it. Furthermore, a design freedom can be increased and/or a qualification of components simplified, since in particular a change to the rectifier, for example by the use of other diodes, in particular of another type or from another supplier, would have no effects on the switch elements used. Finally the diode allows the use of the switch element, in particular of the MOSFET, for further tasks and thus opens up further design possibilities.

The switch element can be embodied in this case as any given single quadrant switch, for example as a bipolar transistor (BJT), as an insulated-gate bipolar transistor (IGBT) without intrinsic diode, as a thyristor (SCR) or also as a Gate Turn Off thyristor (GTO). Moreover the switch element can also be embodied as any given current-bidirectional two-quadrant switch, preferably as a MOSFET, in particular with an intrinsic antiparallel diode. The use of a MOSFET enables an advantageous voltage activation as opposed to a less advantageous current activation to be implemented. The protective diode is in particular connected in series with the switch element in such a way that it conducts during a discharge process of the bus capacitor. The protective diode can be provided to prevent a flow of current through the switch element during charging of the bus capacitor during the positive network voltage partial cycles and/or the negative network voltage partial cycles.

The protective diode is preferably connected antiparallel to the diode of the rectifier connected in parallel with the switch element. When the switch element is embodied as a MOSFET with integrated diode, the protective diode is preferably charged antiparallel to the intrinsic diode. Both the switch element and also the protective diode preferably have a comparable current capacity, since the same current flows through them during operation. Moreover, the switch element, embodied in particular as a MOSFET, and also the protective diode, preferably have a comparable dielectric strength, in particular of at least 650 V and preferably in the range of 800 V to 1000 V, in order to be able to withstand voltage peaks, caused for example by a lightning strike, without any damage.

It is further proposed that the discharging unit has a control unit for control of the switch elements. Through this a partial discharging of the bus capacitors can advantageously be controlled especially precisely. A “control unit” is to be understood in this case as an electronic unit, which is provided for open-loop and/or closed-loop control of at least the switch elements of the discharging unit. Preferably the control unit comprises a processing unit and in particular in addition to the processing unit a memory unit with an open-loop and/or closed-loop control program stored therein, which is intended to be executed by the processing unit. The control unit can be embodied, at least partly, in one piece with a main control unit of an induction hob having the induction hob apparatus.

Moreover it is proposed that the control unit is provided to activate the switch elements for a complete discharging of the bus capacitor. Such an embodiment enables an especially efficient complete discharging of the bus capacitor to be made possible. In an alternative or additional embodiment, it is proposed that the control unit is provided to activate the switch elements for a partial discharging of the bus capacitor. This advantageously enables a partial discharging of the bus capacitor to a desired voltage to be made possible especially efficiently. Preferably the control unit is provided, in a first configuration of the discharging unit, for activation of the switch elements for a complete discharging of the bus capacitor and in a second configuration of the discharging unit is provided for activation of the switch elements for a partial discharging of the bus capacitor, wherein a degree of discharging of the bus capacitor is preferably able to be varied by a switch-on duration of at least one of the switch elements able to be controlled by the control unit.

Moreover, it is proposed that at least one of the switch elements is able to be controlled directly by the control unit. This advantageously enables an especially compact and efficient embodiment to be achieved. It is conceivable for all switch elements of the discharging unit to be able to be controlled directly by the control unit. Depending on the type and arrangement of the switch elements, a direct control of at least one of the switch elements by the control unit is however not possible or expedient in all embodiments of the present invention, which is why it is proposed that the discharging unit has at least one auxiliary switch element, via which at least one of the switch elements is able to be controlled indirectly by the control unit. This type of embodiment advantageously enables a secure control of the switch elements to be made possible. Preferably the auxiliary switch element is provided for an isolation of the control unit in relation to the current supply network. Without being restricted to this, the auxiliary switch element can be embodied for example as an optocoupler or the like. The discharging unit can comprise a plurality of auxiliary switch elements, in particular at least one auxiliary switch element for each switch element of the discharging unit.

The switch elements of the discharging unit could be embodied as mechanical and/or electromechanical switch elements, in particular as relays. In an advantageous embodiment it is proposed however that at least one of the switch elements is embodied as a semiconductor switch element. Such an embodiment enables an especially rapid and precise control of the switch element or of the switch elements to be made possible. Preferably all switch elements of the discharging unit are embodied as semiconductor switch elements.

Furthermore it is proposed that at least one of the switch elements is embodied as a thyristor switch element. This advantageously enables an especially compact discharging unit to be provided using simple technical means. A “thyristor switch element” is to be understood as a semiconductor switch element that is constructed from four or more semiconductor layers of alternating doping. The thyristor switch element could, without being restricted thereto, for example be embodied as a GTO thyristor (Gate Turn Off) or as a GCT (Gate Commutated Thyristor) or as an IGCT (Integrated Gate Commutated Thyristor) or as a thyristor tetrode or as a photo thyristor or as an LTT (Light Triggered Thyristor) or as a DIAC or as a TRIAC, preferably as an optoTRIAC, or the like. It is conceivable for all switch elements of the discharging unit to be embodied as thyristor switch elements. Preferably at least the first switch element of the discharging unit, in particular the high-side switch element, is embodied as a thyristor element, wherein a second switch element, in particular the low-side switch element, can be embodied as another type of semiconductor switch element, for example as a transistor.

In one advantageous embodiment it is proposed that at least one of the switch elements is embodied as an optoTRIAC. The use of switch elements that are embodied as optoTRIACs advantageously enables an additional control voltage source for controlling the switch elements to be dispensed with. Thus an efficiency, in particular cost efficiency, can advantageously be further improved. Moreover, switch elements that are embodied as optoTRIACs advantageously exhibit an intrinsic electrical isolation, so that additional insulation can be dispensed with and a cost efficiency can be improved yet further.

It is further proposed that at least one of the switch elements is embodied as a transistor. This advantageously enables an efficiency to be further improved, since transistors involve components that can be produced in large volumes and are therefore cost-effective to obtain. The at least one switch element of the discharging unit embodied as a transistor can, without being restricted thereto, be embodied for example as an Organic Field Effect Transistor (OFET) or as an Insulated Gate Bipolar Transistor (IGBT) and preferably as a Metal-Oxide Semiconductor Field Effect Transistor (MOSFET). It is conceivable for all switch elements of the discharging unit to be embodied as transistors.

It is moreover proposed that the high-side switch element is embodied as a PNP transistor. Preferably the switch element embodied as a PNP transistor is designed to be triggered by a level converter. Such an embodiment advantageously enables a control voltage source for supply of the high-side switch element to be dispensed with. In such an embodiment any other of the types of switch element described above, for example a transistor or a thyristor switch element, can be used for the low-side switch element. In one embodiment the discharging unit with a high-side switch element embodied as a PNP transistor preferably has at least one auxiliary switch element, which is likewise embodied as a PNP transistor, which is connected to the high-side switch element in a Darlington circuit. This advantageously enables a greater amplification and thus a complete discharging of the bus capacitor to be made possible. It is also conceivable as an alternative for an auxiliary switch element to be dispensed with and for the high-side switch element to be embodied as a Darlington transistor in PNP-PNP form.

In an alternative advantageous embodiment it is proposed that both switch elements are embodied as NPN transistors. Such an embodiment can advantageously enable a cost efficiency to be improved yet further, as NPN transistors, in particular N-MOSFETs, compared to PNP transistors, are much more widely available on the market and are therefore obtainable in large volumes and from various manufacturers and at especially low cost. Preferably the switch elements embodied as NPN transistors are embodied as N-MOSFETs.

The invention further relates to an induction hob with at least one induction hob apparatus as claimed in one of the previously described embodiments. Such an induction hob is characterized in particular by the advantageous properties that can be achieved by the features of the induction hob apparatus described above. The induction hob can have a number of the induction hob apparatuses described above.

The invention moreover relates to a method for operating an induction hob apparatus as claimed in one of the previously described embodiments. The method preferably comprises at least two method steps. In a first method step of the method the bus capacitor is connected via a charging path during a positive network voltage partial cycle and/or via the second charging path during a negative network voltage partial cycle to the network connection and charged via the rectifier. In a second method step of the method the bus capacitor is at least partially or completely discharged, and this is undertaken by the switch elements of the discharging unit, during an entire network voltage partial cycle or a part of a network voltage partial cycle, being closed and a discharging path being enabled from the bus capacitor back to the network connection.

The induction hob apparatus is not intended here to be restricted to the application and form of embodiment described above. In particular the induction hob apparatus, for fulfilling a functionality described here, can have a number of individual elements differing from the number of elements, components and units stated herein.

Further advantages will emerge from the description of the drawings given below. In the drawing five exemplary embodiments of the invention are shown. The drawing, the description and the claims contain numerous features in combination. The person skilled in the art will expediently also consider the features individually and combine them to form useful further combinations.

In the figures:

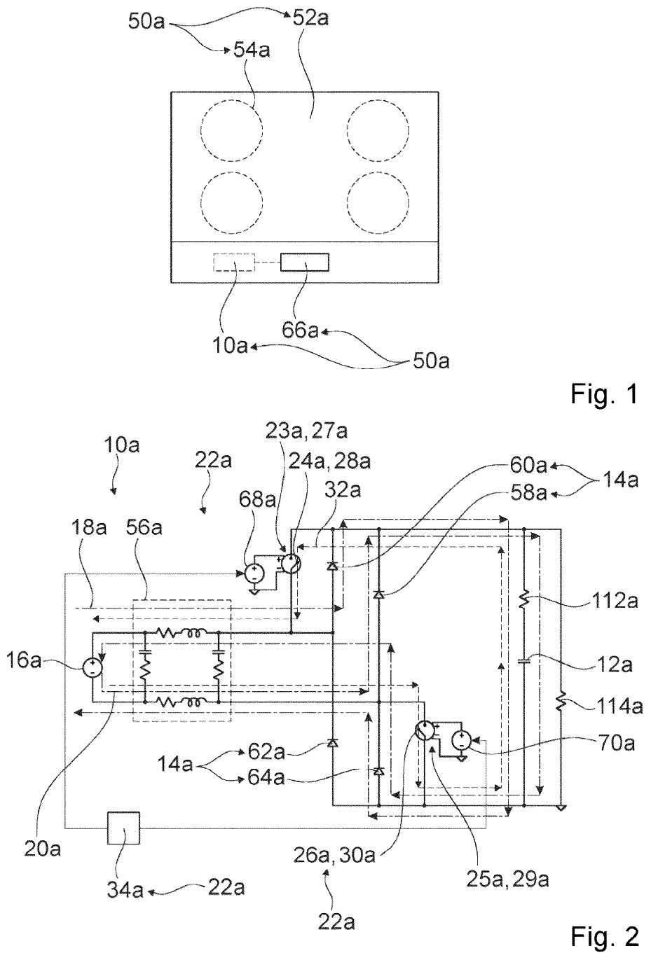

FIG. 1 shows an induction hob with an induction hob apparatus in a schematic view,

FIG. 2 shows a schematic electrical circuit diagram of the induction hob apparatus with a bus capacitor, a rectifier, a network connection and a discharging unit for at least partial discharging of the bus capacitor,

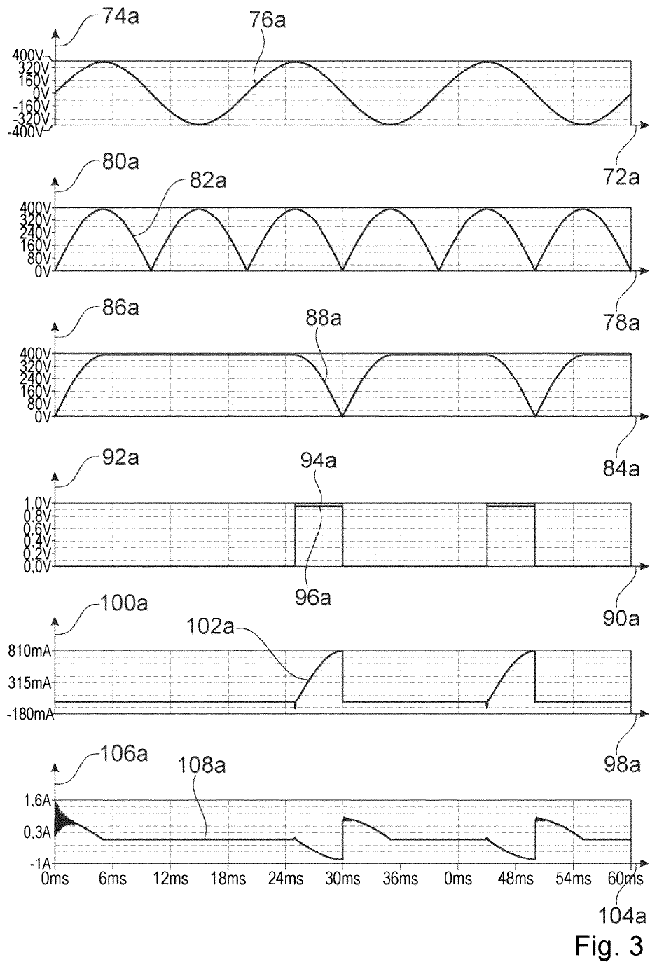

FIG. 3 shows six schematic diagrams for illustration of a way in which the induction hob apparatus functions in a first configuration of the discharging unit,

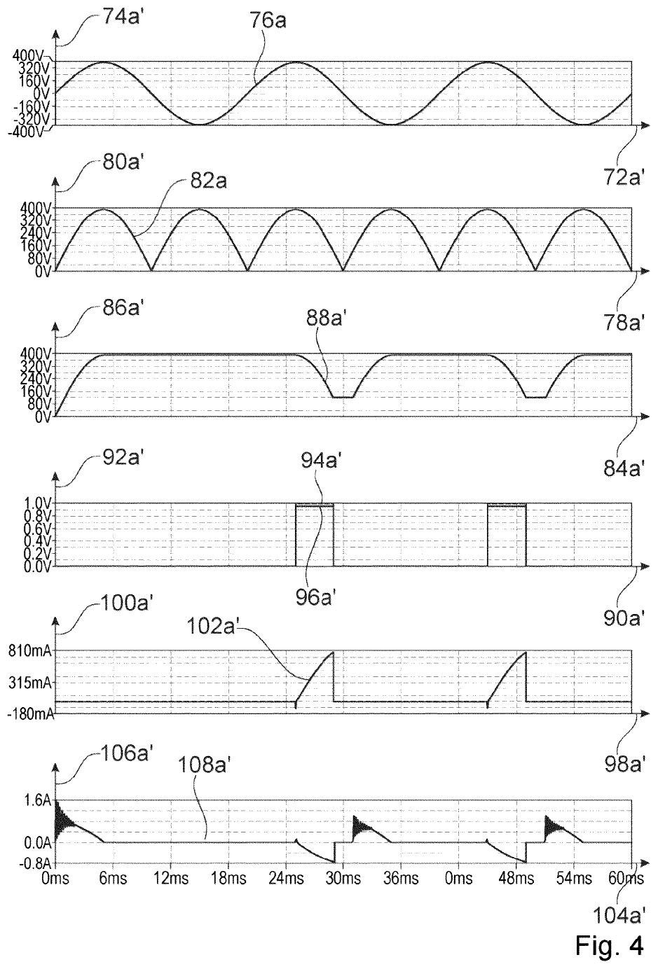

FIG. 4 shows six schematic diagrams for illustration of a way in which the induction hob apparatus functions in a second configuration of the discharging unit,

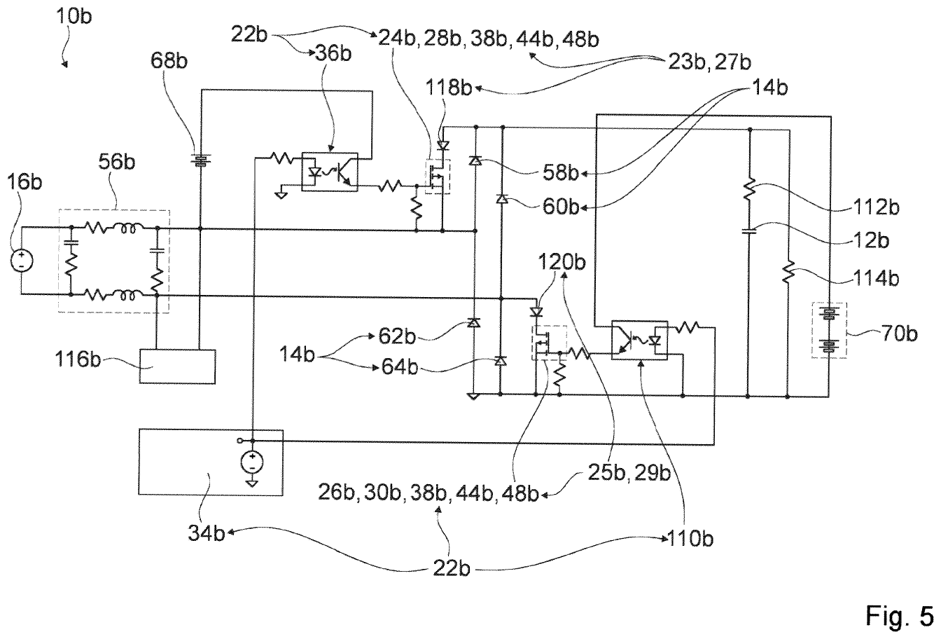

FIG. 5 shows a further exemplary embodiment of an induction hob apparatus in a schematic electrical circuit diagram,

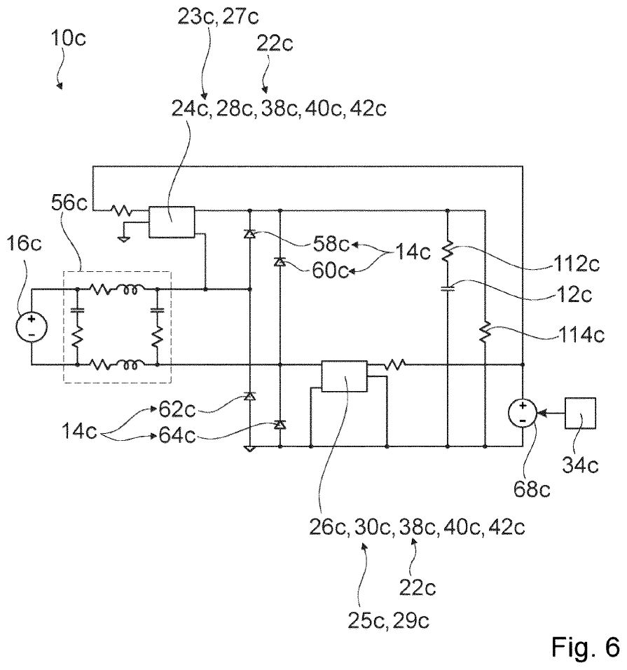

FIG. 6 shows a further exemplary embodiment of an induction hob apparatus in a schematic electrical circuit diagram,

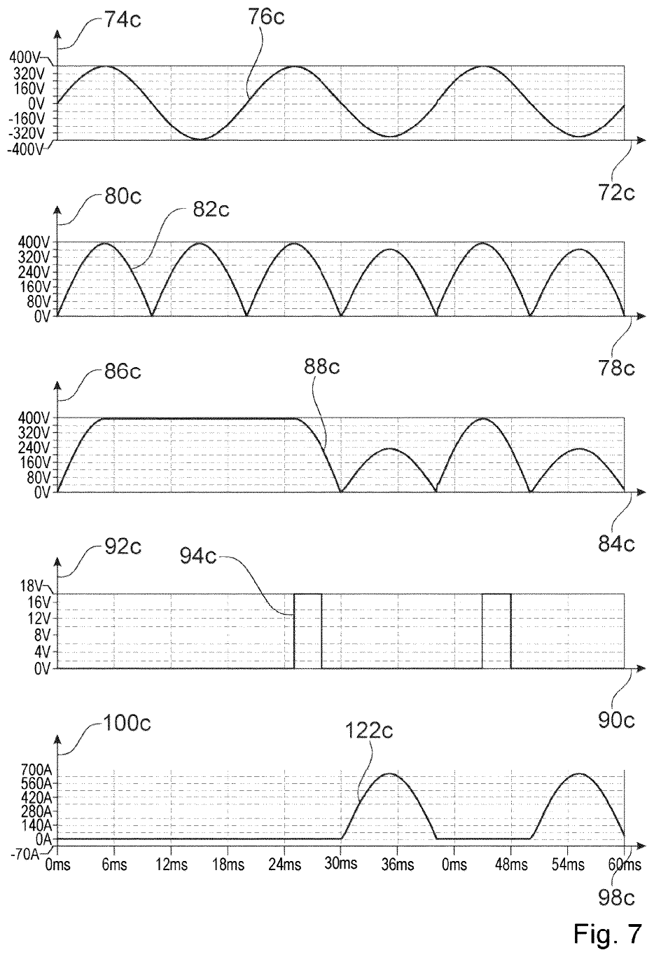

FIG. 7 shows five schematic diagrams for illustration of a way in which the induction hob apparatus of the exemplary embodiment of FIG. 5 functions,

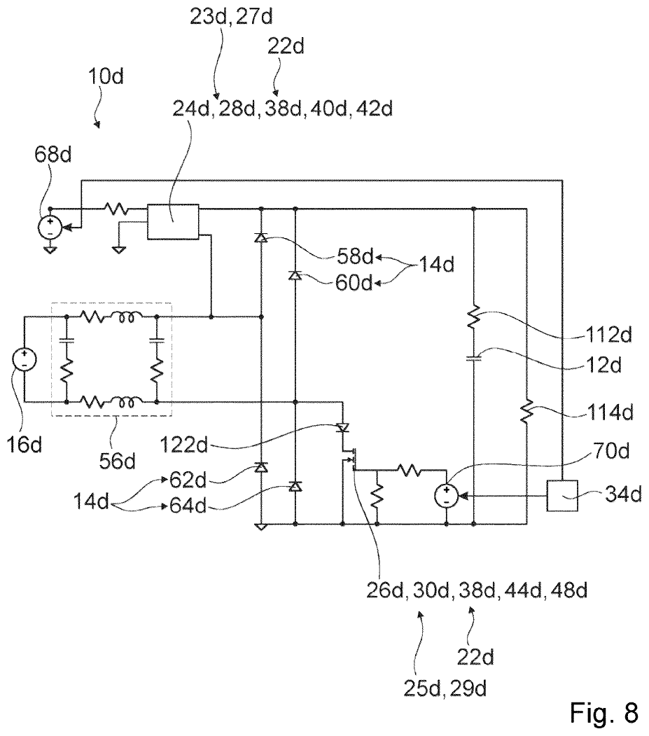

FIG. 8 shows a further exemplary embodiment of an induction hob apparatus in a schematic electrical circuit diagram,

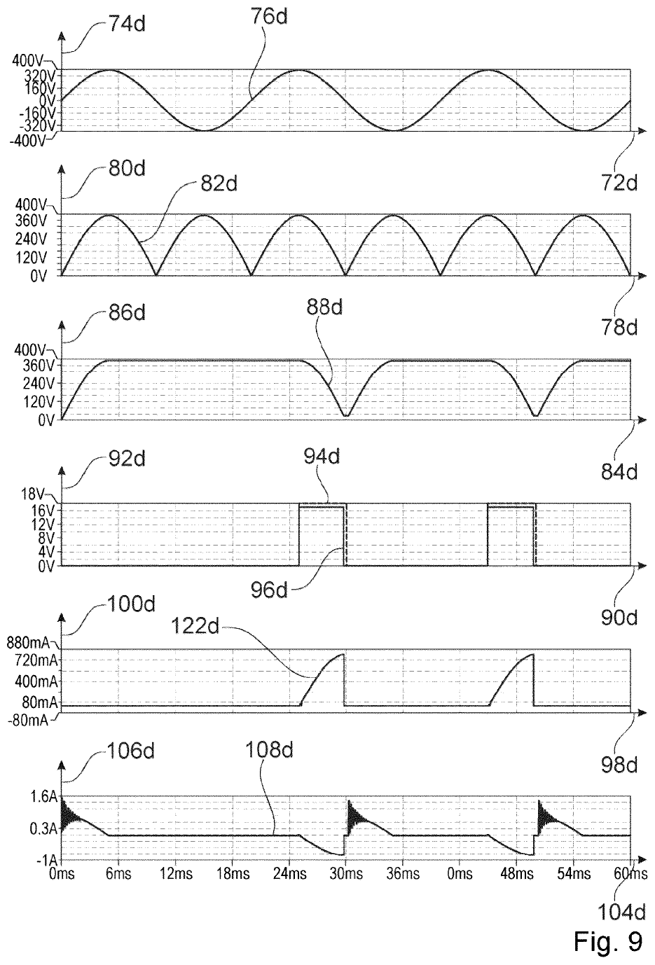

FIG. 9 shows six schematic diagrams for illustration of a way in which the induction hob apparatus of the exemplary embodiment of FIG. 7 functions,

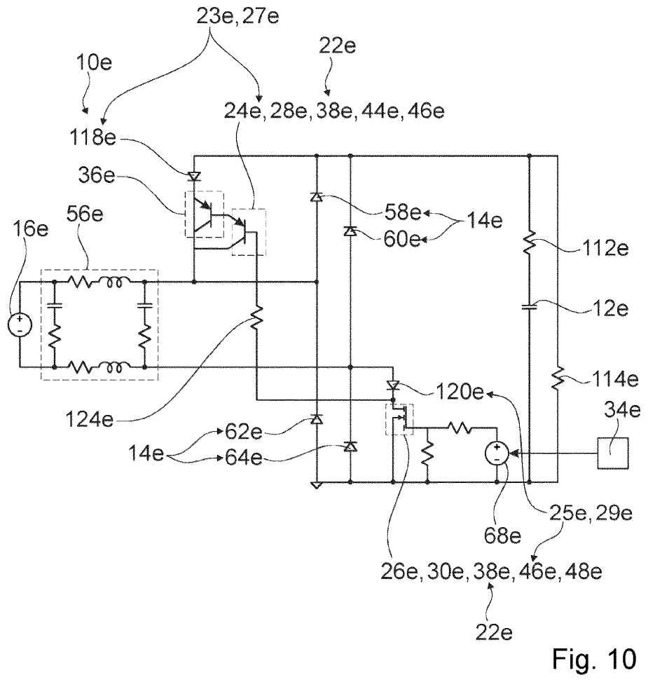

FIG. 10 shows a further exemplary embodiment of an induction hob apparatus in a schematic electrical circuit diagram, and

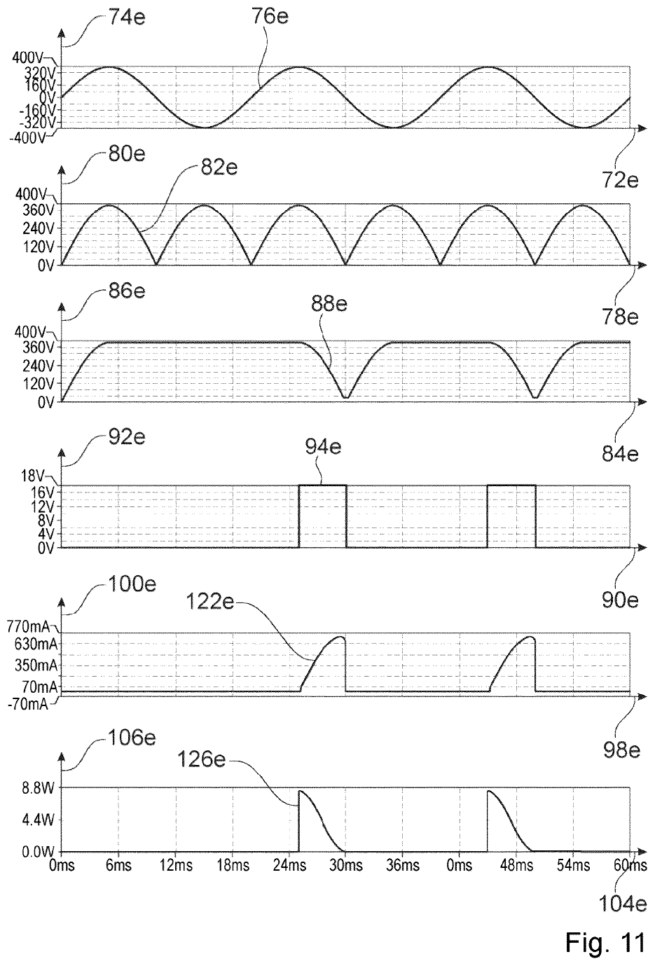

FIG. 11 shows six schematic diagrams for illustration of a way in which the induction hob apparatus of the exemplary embodiment of FIG. 9 functions.

FIG. 1 shows an induction hob 50a in a schematic diagram. The induction hob 50a comprises a hob plate 52a and four inductors 54a, which are installed below the hob plate 52a.

Just one object of objects that are present multiple times in the figures is provided with a reference character.

The induction hob 50a has a main control unit 66a, which comprises a rectifier unit (not shown) for supply of energy to the inductors 52a.

The induction hob 50a has an induction hob apparatus 10a. In an installed state of the induction hob 50a the induction hob apparatus 10a is connected to the rectifier unit of the main control unit 66a.

FIG. 2 shows a simplified and schematic electrical circuit diagram of the induction hob apparatus 10a. The induction hob apparatus 10a has a network connection 16a for connection to a current supply network (not shown).

The induction hob apparatus 10a in the present example has a filter unit 56a, which is provided for reducing the influence of interference.

The induction hob apparatus 10a further has at least one rectifier 14a for rectification of the alternating current provided by the current supply network. The rectifier 14a is embodied in the present example as a single-phase full-wave rectifier. The rectifier 14a comprises four diodes 58a, 60a, 62a, 64a in the present example, these being a first diode 58a, a second diode 60a, a third diode 62a and a fourth diode 64a.

The induction hob apparatus 10a has at least one bus capacitor 12a. The induction hob apparatus 10a has an electrical resistor 112a for charging the bus capacitor 12a, which is arranged electrically in series with the bus capacitor 12a.

In the schematic electrical circuit diagram of FIG. 2, for the sake of simplicity, an equivalent resistance 114a is shown, which is arranged electrically in parallel with the bus capacitor 12a. The equivalent resistance 114a represents all electrical loads that can be connected downstream of the bus capacitor 12a, for example rectifiers (not shown) of the main control unit 66a of the induction hob 50a and/or of at least one of the inductors 54a (cf. FIG. 1) and/or the like.

The bus capacitor 12a is connected to the network connection 16a via the rectifier 14a via at least one first charging path 18a for charging during a positive network voltage partial cycle. The first diode 58a and the fourth diode 64a of the rectifier 14a are assigned to the first charging path 18a. During the positive network voltage partial cycle, the bus capacitor 12a is connected via the first diode 58a and the fourth diode 64a of the rectifier 14a to the network connection 16a and can be charged via the first charging path 18a.

The bus capacitor 12a is connected to the network connection 16a via the rectifier via at least one second charging path 20a for charging during a negative network voltage partial cycle 14a. The second diode 60a and the third diode 62a of the rectifier 14a are assigned to the second charging path 20a. During the negative network voltage partial cycle, the bus capacitor 12a is connected via the second diode 60a and the third diode 62a of the rectifier 14a to the network connection 16a and can be charged via the second charging path 20a.

The induction hob apparatus 10a has a discharging unit 22a. The discharging unit 22a comprises at least two switch units 23a, 25a each with at least one switch element 24a, 26a for periodic discharging of the bus capacitor 12a via the current supply network. A first switch unit 23a of the discharging unit 22a is embodied as a high-side switch unit 27a. A second switch unit 25a of the discharging unit 22a is embodied as a low-side switch unit 29a. In the present exemplary embodiment the switch elements 24a, 26a are each embodied as electromechanical relays. A first switch element 24a of the discharging unit 22a is embodied as a high-side switch element 28a. The high-side switch element 28a is arranged between a positive conductor of the network connection 16a and the bus capacitor 12a. A second switch element 26a of the discharging unit 22a is embodied as a low-side switch element 30a. The low-side switch element 30a is arranged between a neutral conductor of the network connection 16a and the bus capacitor 12a. The switch elements 24a, 26a are provided, in a closed state, to enable a discharging path 32a from the bus capacitor 12a back to the network connection 16a.

The first switch element 24a is arranged electrically in parallel with the first diode 58a of the rectifier 14a. The second switch element 26a is arranged electrically in parallel with the fourth diode 64a of the rectifier 14a. In the present example the discharging unit 22a is therefore provided exclusively for a discharging of the bus capacitor 12a during positive network voltage cycles of an AC network voltage 76a (cf. FIG. 3) provided by the current supply network.

As an alternative or in addition the discharging unit 22a could however be provided for a discharging of the bus capacitor 12a during positive network voltage partial cycles, wherein the first switch element 24a would then have to be arranged electrically in parallel with the second diode 60a and the second switch element 26a electrically in parallel with the third diode 62a or the discharging unit 22a in addition to the switch elements 24a, 26a would have to have a third switch element electrically in parallel with the second diode 60a and a fourth switch element electrically in parallel with the third diode 62a (not shown).

The first switch element 24a has a first control voltage source 68a. The second switch element 26a has a second control voltage source 70a.

The discharging unit 22a has a control unit 34a for controlling the switch elements 24a. The control unit 34a, for controlling the switch elements 24a, 26a, is connected to the first control voltage source 68a and to the second control voltage source 70a. In the present example the control unit 34a is provided to control the first switch element 24a via a first control voltage 94a provided by the first control voltage source 68a (cf. FIG. 3) and the second switch element 26a via a second control voltage 96a provided by the second control voltage source 70a (cf. FIG. 3).

At least one of the switch elements 24a, 26a is able to be controlled directly by the control unit 34a. In the present example both switch elements 24a, 26a are able to be controlled directly by the control unit 34a.

FIG. 3 shows six schematic diagrams for illustration of a way in which the induction hob apparatus 10a functions in a first configuration of the discharging unit 22a.

A time in milliseconds is plotted on an abscissa 72a of a first diagram of FIG. 3. An electrical voltage in volts is plotted on an ordinate 74a of the first diagram. The first diagram shows a temporal course of an AC network voltage 76a, which is provided by the current supply network and is present in an operating state of the induction hob apparatus 10a at the network connection 16a.

The time in milliseconds is plotted on an abscissa 78a of a second diagram of the FIG. 3. An electrical voltage in volts is plotted on an ordinate 80a of the second diagram. The second diagram shows a temporal course of a rectified AC network voltage 82a, in the present example a pulsing DC voltage, in which the rectifier 14a rectifies the AC network voltage 76a in the operating state of the induction hob apparatus 10a.

The time in milliseconds is plotted on an abscissa 84a of a third diagram of FIG. 3. An electrical voltage in volts is plotted on an ordinate 86a of the third diagram. The third diagram shows a temporal course of a capacitor voltage 88a present at the bus capacitor 12a in the first configuration of the discharging unit 22a.

The time in milliseconds is plotted on an abscissa 90a of a fourth diagram of FIG. 3. An electrical voltage in volts is plotted on an ordinate 92a of the fourth diagram. The fourth diagram shows the temporal courses of the first control voltage 94a and the second control voltage 96a, by means of which the control unit 34a controls the first switch element 24a and the second switch element 36a via the control voltage sources 68a, 70a in the first configuration of the discharging unit 22a.

The time in milliseconds is plotted on an abscissa 98a of a fifth diagram of FIG. 3. An electrical current intensity in milliamperes is plotted on an ordinate 100a of the fifth diagram. The fifth diagram shows a temporal course of an electrical current 102a flowing through the first switch element 24a in the first configuration of the discharging unit 22a.

The time in milliseconds is plotted on an abscissa 104a of a sixth diagram of FIG. 3. An electrical current intensity in amperes is plotted on an ordinate 106a of the sixth diagram. The sixth diagram shows a temporal course of a capacitor current 108a, which flows during charging and discharging of the bus capacitor 12a in the first configuration of the discharging unit 22a.

In the first configuration of the discharging unit 22a the control unit 34a is provided to control the switch elements 24a, 26a for a complete discharging of the bus capacitor 12a. As can be inferred from FIG. 3, the control unit 34a activates the switch elements 24a, 26a at a maximum of the rectified AC network voltage 82a during the positive network voltage partial cycle by means of the control voltages 94a, 96a and deactivates the switch elements 24a, 26a at a zero crossing of the AC network voltage 76a in the transition from the positive network voltage partial cycle to the negative network voltage partial cycle, so that the bus capacitor 12a is completely discharged via the discharging path 32a for as long as the control voltages 94a, 96a are present at the switch elements 24a, 26a and said elements are closed.

FIG. 4 shows six further schematic diagrams for illustration of a way in which the induction hob apparatus 10a operates in a second configuration of the discharging unit 22a.

A time in milliseconds is plotted on an abscissa a 72a′ of a first diagram of FIG. 4. An electrical voltage in volts is plotted on an ordinate 74a′ of the first diagram. The first diagram of FIG. 4 once again shows the temporal course of the AC network voltage 76a.

A time in milliseconds is plotted on an abscissa 78a′ of a second diagram of FIG. 4. An electrical voltage in volts is plotted on an ordinate 80a′ of the second diagram. The second diagram once again shows the temporal course of the rectified AC network voltage 82a.

The time in milliseconds is plotted on an abscissa 84a′ of a third diagram of FIG. 4. An electrical voltage in volts is plotted on an ordinate 86a′ of the third diagram. The third diagram shows a temporal course of a capacitor voltage 88a′ present at the bus capacitor 12a in the second configuration of the discharging unit 22a.

The time in milliseconds is plotted on an abscissa 90a′ of a fourth diagram of FIG. 4. An electrical voltage in volts is plotted on an ordinate 92a′ of the fourth diagram. The fourth diagram shows the temporal courses of a first control voltage 94a′ and of a second control voltage 96a′, by means of which the control unit 34a controls the first switch element 24a and the second switch element 36a via the control voltage sources 68a, 70a in the second configuration of the discharging unit 22a.

The time in milliseconds is plotted on an abscissa 98a′ of a fifth diagram of FIG. 4. An electrical current intensity in milliamperes is plotted on an ordinate 100a′ of the fifth diagram. The fifth diagram shows a temporal course of an electrical current 102a′ flowing through the first switch element 24a in the second configuration of the discharging unit 22a.

The time in milliseconds is plotted on an abscissa 104a′ of a sixth diagram of FIG. 4. An electrical current intensity in amperes is plotted on an ordinate 106a′ of the sixth diagram. The sixth diagram shows a temporal course of a capacitor current 108a′, which flows during charging and discharging of the bus capacitor 12a′ in the second configuration of the discharging unit 22a.

In the second configuration of the discharging unit 22a the control unit 34a is provided to control the switch elements 24a, 26a for a partial discharging of the bus capacitor 12a. In a similar way to the first configuration, the control unit 34a in the second configuration activates the switch elements 24a, 26a at a maximum of the rectified AC network voltage 82a during a positive network voltage partial cycle by means of the control voltages 94a′, 96a′. By contrast with the first configuration, the control unit 34a deactivates the switch elements 24a, 26a in the second configuration before a zero crossing of the AC network voltage 76a, so that the bus capacitor 12a is only partially discharged via the discharging path 32a for as long as the control voltages 94a′, 96a′ are present at the switch elements 24a, 26a and said elements are closed.

Independent of the configuration of the discharging unit 22a there is provision for an activation of the switch elements 24a, 26a at a maximum of the rectified AC network voltage 82a, in order to prevent an overloading of the switch elements 24a, 26a through current peaks, which can occur for example on activation of the switch elements 24a, 26a before the maximum of the rectified AC network voltage 82a, i.e. with a rising voltage. Moreover, there is provision for a deactivation of the switch elements 24a, 26a at the latest at the zero crossing of the AC network voltage 76a. In particular the control unit 34a is provided to deactivate the second switch element 26a at the latest at the zero crossing of the AC network voltage 76a, since otherwise, with a closed second switch element 26a during a negative network voltage partial cycle a short circuit of the network connection 16a via the second switch element 26a would arise.

In a method for operating the induction hob apparatus 10a, the bus capacitor 12a is connected to the network connection 16a and charged via the first charging path 18a during a positive network voltage partial cycle and/or via the second charging path 20a during a negative network voltage partial cycle via the rectifier 14a, and this is undertaken up to the capacitor voltage 88a (cf. third diagram of FIG. 3), which, in a charged state of the bus capacitor 12a, corresponds to a threshold value of the rectified AC network voltage 82a (cf. second diagram of FIG. 3), for example 400 V in the present example. Subsequently the bus capacitor 12a is discharged in the method completely (cf. third diagram of FIG. 3) or partially (cf. third diagram of FIG. 4), and this is undertaken by the first switch element 24a and the second switch element 26a being closed during an entire network voltage partial cycle (cf. fourth diagram of FIG. 3) or part of a network voltage partial cycle (cf. fourth diagram of FIG. 4), in the present example a positive network voltage partial cycle, and by the discharging path 32a from the bus capacitor 12a back to the network connection 16a (cf. FIG. 2) being enabled.

Shown in FIGS. 5 to 11 are four further exemplary embodiments of the invention. The descriptions below are essentially restricted to the differences between the exemplary embodiments wherein, as regards components, features and functions that remain the same, the reader can refer to the description of the exemplary embodiment of FIGS. 1 to 4. To distinguish the exemplary embodiments the letter a is replaced in the reference characters of the exemplary embodiments in FIGS. 1 to 4 by the letters b to e in the reference characters of the exemplary embodiments in FIGS. 5 to 11. With regard to components that remain the same, in particular with regard to components with the same reference characters, the reader can in principle also refer to the drawings and/or the description of the exemplary embodiment of FIGS. 1 to 4.

FIG. 5 shows a further exemplary embodiment of an induction hob apparatus 10b in a schematic electrical circuit diagram. In a similar way to the preceding exemplary embodiment the induction hob apparatus 10b comprises at least one bus capacitor 12b, a rectifier 14b and a network connection 16b for connection to a current supply network (not shown), wherein the bus capacitor 12b is connected to the network connection 16b via at least one first charging path (not shown here, cf. FIG. 2) for charging during a positive network voltage partial cycle and via at least one second charging path (not shown here, cf. FIG. 2) for charging during a negative network voltage partial cycle via the rectifier 14b.

The induction hob apparatus 10b has a discharging unit 22b, which comprises at least two switch units 23b, 25b, these being a high-side switch unit 27b and a low-side switch unit 29b, with at least one switch element 24b, 26b in each case for periodic discharging of the bus capacitor 12b via the current supply network, wherein a first switch element 24b is embodied as a high-side switch element 28b and a second switch element 26b is embodied as a low-side switch element 30b. In a similar way to the preceding exemplary embodiment the switch elements 24b, 26b are provided, in a closed state, to enable a discharging path (not shown here, cf. FIG. 2) from the bus capacitor 12b back to the network connection 16b.

By contrast with the induction hob apparatus 10a from the previous exemplary embodiment, at least one of the switch elements 24b, 26b of the discharging unit 22b is embodied as a semiconductor switch element 38b. In the present example both the first switch element 24b and also the second switch element 26b are embodied as semiconductor switch elements 38b. At least one of the switch elements 24b, 26b is embodied as a transistor 44b. In the present example both the first switch element 24b and also the second switch element 26b are embodied as transistors 44b. In the present exemplary embodiment both switch elements 24b, 26b are embodied as NPN transistors 48b, and are embodied as N-MOSFETs.

The discharging unit 22b has a control unit 34b for controlling the switch elements 24b, 26b. By contrast with the previous exemplary embodiment the control unit 34b is not provided for direct control of the switch elements 24b, 26b. The discharging unit 22b has at least one auxiliary switch element 36b, via which at least one of the switch elements 24b, 26b is able to be controlled indirectly by the control unit 34b. In the present example the discharging unit 22b has a first auxiliary switch element 36b and a second auxiliary switch element 110b. The first auxiliary switch element 36b is connected upstream of the first switch element 24b. Via the first auxiliary switch element 36b the first switch element 24b is able to be controlled by the control unit 34b. The second auxiliary switch element 110b is connected upstream of the second switch element 26b. Via the second auxiliary switch element 110b the second switch element 26b is able to be controlled by the control unit 34b. In the present example the first auxiliary switch element 36b and the second auxiliary switch element 110b are each embodied as optocouplers in order to make it possible to isolate the control unit 34b from the current supply network.

The discharging unit 22b has a first control voltage source 68b for supply of energy to the first auxiliary switch element 36b. The discharging unit 22b has a second control voltage source 70b for supply of energy to the second auxiliary switch element 110b.

The discharging unit 22b has a zero crossing detector 116b, which is provided to detect a zero crossing of the AC network voltage (not shown here, cf. FIGS. 3 and 4), which represents a transition from the positive network voltage partial cycle to the negative network voltage partial cycle. By means of the zero crossing detector 116b it can be ensured that there is a timely deactivation of the switch elements 24b, 26b, in particular of the second switch element 26b by the control unit 34b. A control of the switch elements 24b, 26b can in particular be adapted to a network voltage cycle of an AC network voltage of the power supply network.

The discharging unit 22b, and indeed the high-side switch unit 27b, has a first protective diode 118b. The first protective diode 118b is arranged in the blocking direction as regards a first switch element 24b of the source connection of the NPN transistor 48b and is provided to prevent a flow of current through the first switch element 24b, in particular via its internal diode, during charging of the bus capacitor 12b during the positive network voltage partial cycle via the first charging path. In a similar way the discharging unit 22b, and indeed the low-side switch unit 29b, has a second protective diode 120b, which is arranged in the blocking direction as regards a second switch element 26b embodied as an NPN transistor 48b as a source connection and is provided to prevent a flow of current through the second switch element 26b, in particular via its internal diode during charging of the bus capacitor 12b during the negative network voltage partial cycles via the second charging path. The high-side switch unit 27b and also the low-side switch unit 29b are thus embodied as voltage-bidirectional two-quadrant switches.

FIG. 6 shows a further exemplary embodiment of an induction hob apparatus 10c in a schematic electrical circuit diagram. Similarly to the previous exemplary embodiments, the induction hob apparatus 10c comprises at least one bus capacitor 12c, a rectifier 14c and a network connection 16c for connection to a current supply network (not shown), wherein the bus capacitor 12c is connected to the network connection 16c via the rectifier 14c via at least one first charging path (not shown here, cf. FIG. 2) for charging during a positive network voltage partial cycle and via at least one second charging path (not shown here, cf. FIG. 2) for discharging during a negative network voltage partial cycle.

The induction hob apparatus 10c has a discharging unit 22c, which comprises at least two switch units 23c, 25c, these being a high-side switch unit 27c and a low-side switch unit 29c, each with at least one switch element 24c, 26c for periodic discharging of the bus capacitor 12c via the current supply network, wherein a first switch element 24c is embodied as a high-side switch element 28c and a second switch element 26c as a low-side switch element 30c Similarly to the previous exemplary embodiment the switch elements 24c, 26c are provided, in a closed state, to enable a discharging path (not shown here, cf. FIG. 2) from the bus capacitor 12c back to the network connection 16c.

By contrast with the previous exemplary embodiments, at least one of the switch elements 24c, 26c is embodied as a thyristor switch element 40c. In the present example both the first switch element 24c and also the second switch element 26c are embodied as thyristor switch elements 40c. At least one of the switch elements 24c, 26c is embodied as an optoTRIAC 42c. In the present example both the first switch element 24c and also the second switch element 26c are embodied as optoTRIACs 42c.

The discharging unit 22c has a control unit 34c for controlling the switch elements 24c, 26c. At least one of the switch elements 24c, 26c is able to be controlled directly by the control unit 34c. In the present example both switch elements 24c, 26c are able to be controlled directly by the control unit 34c.

By contrast with the previous exemplary embodiments, the discharging unit 22c has only one first control voltage source 68c. The switch elements 24a, 26c are able to be controlled at the same time by the control unit 34c by means of a first control voltage 94c provided by the first control voltage source 68c (cf. FIG. 7).

FIG. 7 shows five schematic diagrams for illustration of a way in which the induction hob apparatus 10c functions in a first configuration of the discharging unit 22c.

A time in milliseconds is plotted on an abscissa 72c of a first diagram of FIG. 7. An electrical voltage in volts is plotted on an ordinate 74c of the first diagram. The first diagram shows a temporal course of an AC network voltage 76c, which is provided by the current supply network and is present at the network connection 16c in an operating state of the induction hob apparatus 10c.

The time in milliseconds is plotted on an abscissa 78c of a second diagram of FIG. 7. An electrical voltage in volts is plotted on an ordinate 80c of the second diagram. The second diagram shows a temporal course of a rectified AC network voltage 82c, in which the rectifier 14c rectifies the AC network voltage 76c in the operating state of the induction hob apparatus 10c.

The time in milliseconds is plotted on an abscissa 84c of a third diagram of FIG. 7. An electrical voltage in volts is plotted on an ordinate 86c of the third diagram. The third diagram shows a temporal course of a capacitor voltage 88c present at the bus capacitor 12c in the first configuration of the discharging unit 22c.

The time in milliseconds is plotted on an abscissa 90c of a fourth diagram of FIG. 7. An electrical voltage in volts is plotted on an ordinate 92c of the fourth diagram. The fourth diagram shows a temporal course of the first control voltage 94c, by means of which the control unit 34c controls the first switch element 24c and the second switch element 26c via the first control voltage source 68c in the first configuration of the discharging unit 22c.

The time in milliseconds is plotted on an abscissa 98c of a fifth diagram of FIG. 7. An electrical current intensity in amperes is plotted on an ordinate 100c of the fifth diagram. The fifth diagram shows a temporal course of an electrical current 122c flowing through the first switch element 24c and the second switch element 26c in the first configuration of the discharging unit 22c. As can be inferred from the fifth diagram, after a complete discharging of the bus capacitor 12c, very high currents of up to 700 A flow through the switch elements 24c, 26c although no control voltage 94c is present any longer. The reason for this is that the thyristor switching elements 40c are components that can be switched on that, after a switching-on by application of the control voltage 94c to its gate electrodes, also after a deactivation of the control voltage 94c when no gate current is flowing any more at the gate electrodes, remain conductive, the result being that the network connection 16c is short circuited during the subsequent negative network voltage partial cycle. One solution for this problem could lie in the use of GTO (Gate Turn Off) thyristors as switch elements 24c, 26c instead of optoTRIACs. A further solution to this problem is shown in the following exemplary embodiment of FIGS. 8 and 9.

FIG. 8 shows a further exemplary embodiment of an induction hob apparatus 10d in a schematic electrical circuit diagram. Similarly to the previous exemplary embodiments, the induction hob apparatus 10d comprises at least one bus capacitor 12d, a rectifier 14d and a network connection 16d for connection to a current supply network (not shown), wherein the bus capacitor 12d is connected to the network connection 16d via the rectifier 14d via at least one first charging path (not shown here, cf. FIG. 2) for charging during a positive network voltage partial cycle and via at least one second charging path (not shown here, cf. FIG. 2) for charging during a negative network voltage partial cycle.

The induction hob apparatus 10d has a discharging unit 22d which comprises at least two switch units 23d, 25d, these being a high-side switch unit 27d and a low-side switch unit 29d, each with at least one switch element 24d, 26d for periodic discharging of the bus capacitor 12d via the current supply network, wherein a first switch element 24d is embodied as a high-side switch element 28d and a second switch element 26d as a low-side switch element 30d. Similarly to the previous exemplary embodiments, the switch elements 24d, 26d are provided, in a closed state, to enable a discharging path (not shown here, cf. FIG. 2) from the bus capacitor 12d back to the network connection 16d.

Similarly to the previous exemplary embodiment shown in FIGS. 6 and 7, at least one of the switch elements 24d, 26d is embodied as a thyristor switch element 40d. By contrast with the discharging unit 22c from the previous exemplary embodiment, in the exemplary embodiment in the present example only the first switch element 24d is embodied as a thyristor switch element 40d and it is embodied as an optoTRIAC 42d. The second switch element 26d is embodied as a transistor 44d, and is embodied as an NPN transistor 48d, in particular as an N-MOSFET.

The discharging unit 22d has a control unit 34d for controlling the switch elements 24d, 26d. At least one of the switch elements 24d, 26d is able to be controlled directly by the control unit 34d. In the present example both switch elements 24d, 26d are able to be controlled directly by the control unit 34d. The first switch element 24d is able to be controlled by means of a first control voltage 94d (cf. FIG. 9) provided by a first control voltage source 68d and the second switch elements 26d is able to be controlled by means of a second control voltage source 70d provided directly by a second control voltage 96d (cf. FIG. 9) by the control unit 34d.

FIG. 9 shows six schematic diagrams for illustration of a way in which the induction hob apparatus 10d functions.

A time in milliseconds is plotted on an abscissa 72d of a first diagram of FIG. 9. An electrical voltage in volts is plotted on an ordinate 74d of the first diagram. The first diagram shows a temporal course of an AC network voltage 76d, which is provided by the current supply network and is present at the network connection 16d in an operating state of the induction hob apparatus 10d.

The time in milliseconds is plotted on an abscissa 78d of a second diagram of FIG. 9. An electrical voltage in volts is plotted on an ordinate 80d of the second diagram. The second diagram shows a temporal course of a rectified AC network voltage 82d, in which the rectifier 14d rectifies the AC network voltage 76d in the operating state of the induction hob apparatus 10d.

The time in milliseconds is plotted on an abscissa 84d of a third diagram of FIG. 9. An electrical voltage in volts is plotted on an ordinate 86d of the third diagram. The third diagram shows a temporal course of a capacitor voltage 88d present at the bus capacitor 12d.

The time in milliseconds is plotted on an abscissa 90d of a fourth diagram of FIG. 9. An electrical voltage in volts is plotted on an ordinate 92d of the fourth diagram. The fourth diagram shows the temporal courses of the first control voltage 94d and of the second control voltage 96d, by means of which the control unit 34d controls the first switch element 24d and the second switch element 36d via the control voltage sources 68d, 70d of the discharging unit 22d.

The time in milliseconds is plotted on an abscissa 98d of a fifth diagram of FIG. 9. An electrical current in milliamperes is plotted on an ordinate 100d of the fifth diagram. The fifth diagram shows a temporal course of an electrical current 122d flowing through the first switch element 24d in the first configuration of the discharging unit 22d.

The time in milliseconds is plotted on an abscissa 104d of a sixth diagram of FIG. 9. An electrical current intensity in amperes is plotted on an ordinate 106a of the sixth diagram. The sixth diagram shows a temporal course of a capacitor current 108d that flows during charging and discharging of the bus capacitor 12d of the discharging unit 22d.

As can be inferred from the fourth diagram, the control unit 34d deactivates the second control voltage source 70d before the first control voltage source 68d. When the second switch element 26d embodied as an NPN transistor 48d is switched off before the first switch element 24d embodied as an optoTRIAC 42d, this results in the TRIAC current being forcibly extinguished in the first switch element 24d and in the first switch element 24d being switched off before the zero crossing of the AC network voltage 76d. The problem described with the aid of the previous exemplary embodiment of short circuiting of the network connection 16c does not exist in the present exemplary embodiment of the induction hob apparatus 10d. As can be inferred from the third diagram, a complete discharging of the bus capacitor 12d is not possible in this manner.

FIG. 10 shows a further exemplary embodiment of an induction hob apparatus 10e in a schematic electrical circuit diagram. Similarly to the previous exemplary embodiments the induction hob apparatus 10 comprises at least one bus capacitor 12e, a rectifier 14e and a network connection 16e for connection to a current supply network (not shown), wherein the bus capacitor 12e is connected to the network connection 16e via at least one first charging path (not shown here, cf. FIG. 2) for charging during a positive network voltage partial cycle and via at least one second charging path (not shown here, cf. FIG. 2) for charging during a negative network voltage partial cycle via the rectifier 14e.

The induction hob apparatus 10e has a discharging unit 22e, which comprises at least two switch units 23e, 25e, these being a high-side switch unit 27e and a low-side switch unit 29e, each with at least one switch element 24e, 26e for periodic discharging of the bus capacitor 12e via the current supply network, wherein a first switch element 24e is embodied as a high-side switch element 28e and a second switch element 26e as a low-side switch element 30e. Similarly to the previous exemplary embodiments the switch elements 24e, 26e are provided, in a closed state, to enable a discharging path (not shown here, cf. FIG. 2) from the bus capacitor 12e back to the network connection 16e.

The discharging unit 22e has a control unit 34e for controlling the switch elements 24e, 26e. At least one of the switch elements 24e, 26e is able to be controlled directly by the control unit 34e.

Similarly to the previous exemplary embodiment shown in FIGS. 8 and 9, the second switch element 26e is embodied as a transistor 44e, and is embodied as an NPN transistor 48e, in particular as an N-MOSFET. By contrast with the previous exemplary embodiment, the high-side switch element 28e is embodied as a PNP transistor 46e. The discharging unit 36e has at least one auxiliary switch element 36e. In the present example the auxiliary switch element 36e is likewise embodied as a PNP transistor 46e and is linked to the first switch element 24e in a Darlington circuit in order to make possible a complete discharging of the bus capacitor 12e.

A source connection of the first switch element 24e is connected to the drain connection of the second switch element 26e via a resistor 124e. This enables a second voltage source to be dispensed with and the switch elements 24e, 26e can be controlled via a first control voltage source 68e by the control unit 34e.

FIG. 11 shows six schematic diagrams for illustration of a way in which the induction hob apparatus 10e functions.

A time in milliseconds is plotted on an abscissa 72e of a first diagram of FIG. 11. An electrical voltage in volts is plotted on an ordinate 74e of the first diagram. The first diagram shows a temporal course of an AC network voltage 76e, which is provided by the current supply network and is present in an operating state of the induction hob apparatus 10e at the network connection 16e.

The time in milliseconds is plotted on an abscissa 78e of a second diagram of FIG. 3. An electrical voltage in volts is plotted on an ordinate 80e of the second diagram. The second diagram shows a temporal course of a rectified AC network voltage 82e, in the present example a pulsing DC voltage, in which the rectifier 14e rectifies the AC network voltage 76e in an operating state of the induction hob apparatus 10e.

The time in milliseconds is plotted on an abscissa 84e of a third diagram of FIG. 11. An electrical voltage in volts is plotted on an ordinate 86e of the third diagram. The third diagram shows a temporal course of a capacitor voltage 88e present at the bus capacitor 12 in the first configuration of the discharging unit 22e.

The time in milliseconds is plotted on an abscissa 90e of a fourth diagram of FIG. 11. An electrical voltage in volts is plotted on an ordinate 92e of the fourth diagram. The fourth diagram shows a temporal course of a first control voltage 94e, by means of which the control unit 34e controls the first switch element 24e and the second switch element 36e via the first control voltage source 68e.

The time in milliseconds is plotted on an abscissa 98e of a fifth diagram of FIG. 11. An electrical current intensity in milliamperes is plotted on an ordinate 100e of the fifth diagram. The fifth diagram shows a temporal course of an electrical current 122e flowing through the resistor 124e.

The time in milliseconds is plotted on an abscissa 104e of a sixth diagram of FIG. 11. A power in watts is plotted on an ordinate 106e of the sixth diagram. The sixth diagram shows a temporal course of an electrical power 126e falling at the resistor 124e during discharging of the bus capacitor 12e. As can be inferred from the sixth diagram, a discharging of the bus capacitor 12e in the present exemplary embodiments, and by contrast with the previous exemplary embodiments, is linked to increased dissipative losses, which fall at the resistor 124e.

### List of Reference Characters

10 Induction hob apparatus
12 Bus capacitor
14 Rectifier
16 Network connection
18 First charging path
20 Second charging path
22 Discharging unit
23 First switch unit
24 First switch element
25 Second switch unit
26 Second switch element
27 High-side switch unit
28 High-side switch element
29 Low-side switch unit
30 Low-side switch element
32 Discharging path
34 Control unit
36 First auxiliary switch element
38 Semiconductor switch element
40 Thyristor switch element
42 OptoTRIAC
44 Transistor
46 PNP transistor
48 NPN transistor
50 Induction hob
52 Hob plate
54 Inductor
56 Filter unit
58 First diode
60 Second diode
62 Third diode
64 Fourth diode
66 Main control unit
68 First control voltage source
70 Second control voltage source
72 Abscissa
74 Ordinate
76 Ac network voltage
78 Abscissa
80 Ordinate
82 Rectified AC network voltage
84 Abscissa
86 Ordinate
88 Capacitor voltage
90 Abscissa
92 Ordinate
94 First control voltage
96 Second control voltage
98 Abscissa
100 Ordinate
102 Electrical current
104 Abscissa
106 Ordinate
108 Capacitor current
110 Second auxiliary switch element
112 Resistor
114 Equivalent resistance
116 Zero crossing detector
118 First protective diode
120 Second protective diode
122 Electrical current
124 Resistor
126 Power

1-16. (canceled)

17. An induction hob apparatus, comprising
a network connection for connection to a current supply network;
a rectifier;
a bus capacitor connected to the network connection via the rectifier via a first charging path for charging during a positive network voltage partial cycle and via a second charging path for charging during a negative network voltage partial cycle; and
a discharging unit comprising at least two switch units, each of the at least two switch units including a switch element for periodic discharging of the bus capacitor via the current supply network, one of the at least two switch units being embodied as a high-side switch unit with a high-side switch element and another one of the at least two switch units being embodied as a low-side switch unit with a low-side switch element,
wherein the switch elements of the at least two switch units are designed to enable, in a closed state, a discharging path from the bus capacitor back to the network connection.

18. The induction hob apparatus of claim 17, wherein the at least two switch units are each embodied as voltage-bidirectional two-quadrant switch.

19. The induction hob apparatus of claim 17, wherein the at least two switch units include each a protective diode which is connected in series with a respective one of the switch elements.

20. The induction hob apparatus of claim 17, wherein the discharging unit includes a control unit designed to control the switch elements.

21. The induction hob apparatus of claim 20, wherein the control unit is designed to control the switch elements for a complete discharging of the bus capacitor.

22. The induction hob apparatus of claim 20, wherein the control unit is designed to control the switch elements for a periodic discharging of the bus capacitor.

23. The induction hob apparatus of claim 20, wherein at least one of the switch elements is controllable directly by the control unit.

24. The induction hob apparatus of claim 20, wherein the discharging unit includes an auxiliary switch element, via which at least one of the switch elements is controllable indirectly by the control unit.

25. The induction hob apparatus of claim 17, wherein at least one of the switch elements is embodied as a semiconductor switch element.

26. The induction hob apparatus of claim 17, wherein at least one of the switch elements is embodied as a thyristor switch element.

27. The induction hob apparatus of claim 17, wherein at least one of the switch elements is embodied as an optoTRIAC.

28. The induction hob apparatus of claim 17, wherein at least one of the switch elements is embodied as a transistor, in particular as a MOSFET.

29. The induction hob apparatus of claim 17, wherein the high-side switch element is embodied as a PNP transistor.

30. The induction hob apparatus of claim 17, wherein the at least two switch elements are embodied as NPN transistors.

31. An induction hob, comprising the induction hob apparatus of claim 17.

32. A method for operation of an induction hob apparatus, the method comprising:
connecting a network connection to a current supply network;
connecting a bus capacitor to the network connection via a rectifier via a first charging path for charging during a positive network voltage partial cycle and via a second charging path for charging during a negative network voltage partial cycle;
periodically discharging the bus capacitor via the current supply network via switch elements of at least two switch units of a discharging unit, with one of the at least two switch units being embodied as a high-side switch unit with a high-side switch element and another one of the at least two being embodied switch units as a low-side switch unit with a low-side switch element; and
establishing a discharging path from the bus capacitor back to the network connection in a closed state of the switch elements.

33. The method of claim 32, further comprising protective diodes connected in series with the switch elements respectively.

34. The method of claim 32, further comprising controlling the switch elements by a control unit of the discharging unit.

35. The method of claim 32, further comprising controlling the switch elements to completely discharge the bus capacitor.

36. The method of claim 32, further comprising controlling the switch elements for a periodic discharging of the bus capacitor.
